(19) United States
(12) Patent Application Publication
(10) Pub. No.: US 2010/0139849 A1
(43) Pub. Date: Jun. 10, 2010

(54) Method And An Apparatus For Producing Exam Table Paper Rolls

(76) Inventor: Andrea Bernacchi, Antraccoli (IT)

Correspondence Address: WILLIAM J. SAPONE;COLEMAN SUDOL SAPONE P.C., 714 COLORADO AVENUE, BRIDGE PORT, CT, 06605, US

(21) Appl. No.: 12/374,812

(22) PCT Filed: Jul. 25, 2007
(86) PCT No.: PCT/IB07/02107

§ 371 Date: Jan. 23, 2009

(30) Foreign Application Priority Data
Jul. 25, 2006 (IT) BO2006A 000553

(51) Int. Cl. B29C 65/52; B29C 59/04

(52) U.S. Cl. 156/209; 156/390

(57) ABSTRACT

A method relates to the production of paper rolls for examination tables, obtained from a tape (100) of embossed paper, having two layers (10, 20), joined together. The band (100) is obtained in known way from two continuous webs (1, 2), subjected to subsequent steps of embossing, glue (C) application, coupling and stabilization. The method includes applying measured quantities of a sanitizing and/or disinfectant substance (S) between the two layers of embossed paper (10, 20) before their joining; preferably, the substance (S) is applied to the same continuous web (1) that is aimed at receiving the glue (C), after the embossing step and contemporarily with the glue (C) application, by spot-application of a mixture (M) in aqueous solution containing suitable percentage of the glue (C) and sanitizing substance (S) to the tops (11A) of the embossing relieves (11.) In this case, the application means (240) for sanitizing substance (S) are formed by the same means (220) for applying the glue (C).

### TECHNICAL FIELD OF THE INVENTION

The invention relates to the technical field concerning the production of disposable paper articles, such as e.g. table-clothes, napkins, wash-clothes, towels and the like.

In particular, the invention relates to paper in rolls for obtaining disposable sheets, used for examination tables in medical surgeries.

The paper used for this purpose is usually of “tissue” type, double-layered and embossed.

### PRIOR ART IN THE INVENTION FIELD

As it is known, the embossing is a permanent deformation made on an originally smooth web of paper by suitable embossing rolls, so as to obtain relieves, arranged according to a prefixed weft or a prefixed pattern, which make the webs crinkled.

Afterwards, glue spots are applied to one of the webs, on the top of the embossing relieves, by an application roll, acting tangential to the embossing roll, counter-rotating with respect thereto and with suitable adjustment.

Then, the two webs, which are to form the two layers, are coupled in accordance with a predetermined pattern, according to which the glue spots of the first web can meet, e.g. the tops of the second web relieves or its hollows.

According to a known technique, the glue used for this operation is an aqueous solution, which dries rapidly and, if necessary, can be mixed with coloring substances; in the last case, color spots, aimed at coloring the article surface, are obtained in points corresponding to the glue spots.

Obviously, in case of food articles and the like it is necessary to use suitable principle for choosing the kind of paper, glue and, if needed, ink, so that the obtained products are anallergic, non-toxic and whatever required by the regulatory standards.

In case of the above mentioned webs, considered their use delicacy, it is very important to offer also good hygiene and aseptic characteristics, besides the above mentioned requirements, for bigger patient's protection.

However, from this point of view, the rolls for the sheet of known type cannot ensure safety much more than other articles for food use; at most, environment conditions during the production can be improved and/or more restrictive measures can be used for the machine parts touching the paper.

### SUMMARY OF THE INVENTION

Therefore, the object of the present invention is to propose a method for producing exam table paper rolls, in which the used paper is more aseptic, due to the application of a suitable sanitizing substance, aimed at passing its properties to the paper layers and at ensuring its effect for a sufficiently long time.

Another object of the invention is to propose an apparatus, which carries out the above mentioned method, by applying measured quantities of sanitizing substance between the two layers of embossed paper, before their joining.

A further object of the invention is to propose an apparatus, which is capable of carrying out said method with production costs and time analogous to those necessary for the corresponding products of known type.

The above mentioned objects are fully obtained by a method and by a corresponding apparatus for producing rolls of tissue paper for examining tables, obtained with a band of embossed paper having two joined layers, said band being obtained from two continuous webs subjected to subsequent steps of embossing, glue application, joining and stabilizing, and with said method including also the application of measured quantities of sanitizing substance between the two layers of embossed paper before their joining.

### BRIEF DESCRIPTION OF DRAWINGS

The characteristic features of the proposed method will become more evident from the following description of some preferred embodiments of the apparatus that carries it out, in accordance with the contents of the claims and with the help of the enclosed figures, in which:

FIG. 1 is a schematic, lateral view of the apparatus according to a first embodiment;

FIGS. 2 and 3 are enlarged views of two possible ways of joining the two layers of embossed paper, according to what has been obtained with the apparatus of FIG. 1;

FIG. 4 shows a version of the apparatus of FIG. 1, which obtains the same results as FIGS. 2 and 3;

FIG. 5 is a schematic, lateral view of the apparatus according to a second embodiment;

FIG. 6 shows, in the same view as in FIG. 2, the results obtained by the apparatus of FIG. 5;

FIG. 7 is a schematic, lateral view of the apparatus according to a third embodiment;

FIG. 8 shows, in the same view as in FIGS. 2 and 6, the results obtained by the apparatus of FIG. 7.

### DETAILED DESCRIPTION OF THE INVENTION

Regarding the above mentioned Figures, the reference numeral 100 indicates an embossed paper band having two layers 10, 20, joined together, aimed at being rolled up in rolls (not shown), from which a plurality of disposable sheets are obtained to be used in medical surgeries.

According to a known technique, the band 100 is obtained from two continuous webs 1, 2, subjected to subsequent steps of embossing, glue C application, coupling and stabilization.

The above mentioned work steps are performed by a known apparatus 200, which includes first rollers 201, 202 for feeding the two continuous webs 1, 2, aimed at forming the layers 10, 20; second rollers 211, 212 for embossing the webs 1, 2; at least one third roller 220 for applying a glue C between the layers 10, 20; and a fourth roller 230, cooperating e.g. with one of said embossing rollers 211, 212 in coupling and stabilizing the layers 10, 20.

The used glue C, as already said in the introductory note, is an aqueous solution, which dries rapidly and which, if necessary, can be mixed with coloring substances.

The method proposed by the present invention includes applying measured quantities of a sanitizing-disinfectant substance S between the two layers of embossed paper 10, 20, before their joining.

Also the sanitizing-disinfectant substance S is an aqueous solution, which dries rapidly and which contains active agents aimed at giving disinfectant and antiseptic features; moreover, the sanitizing-disinfectant substance S releases gradually the active agent, so that its sanitizing action can be spread beyond the application areas, maintaining its characteristics for a reasonably long time, longer than the medium time passing between the production and use of the rolls. Different substances having the above described characteristics are known in many medical uses.

In order to carry out the method, the apparatus 200 includes application means 240, situated upstream of the fourth coupling roller 230 and aimed at applying measured quantities of said sanitizing substance S on at least one of said layers 10, 20, on the side turned toward the other layer.

According to a preferred embodiment of the method, the sanitizing substance S is applied to the same continuous web 1 that is aimed at receiving the glue C, after the embossing step and contemporarily with the glue C application; a mixture M in aqueous solution containing suitable percentage of glue C and sanitizing substance S is spot-applied to the tops 11A of the embossing relieves 11.

In this case, the application means 240 for sanitizing substance S are formed by the same third roller 220 for applying the glue C (FIG. 1).

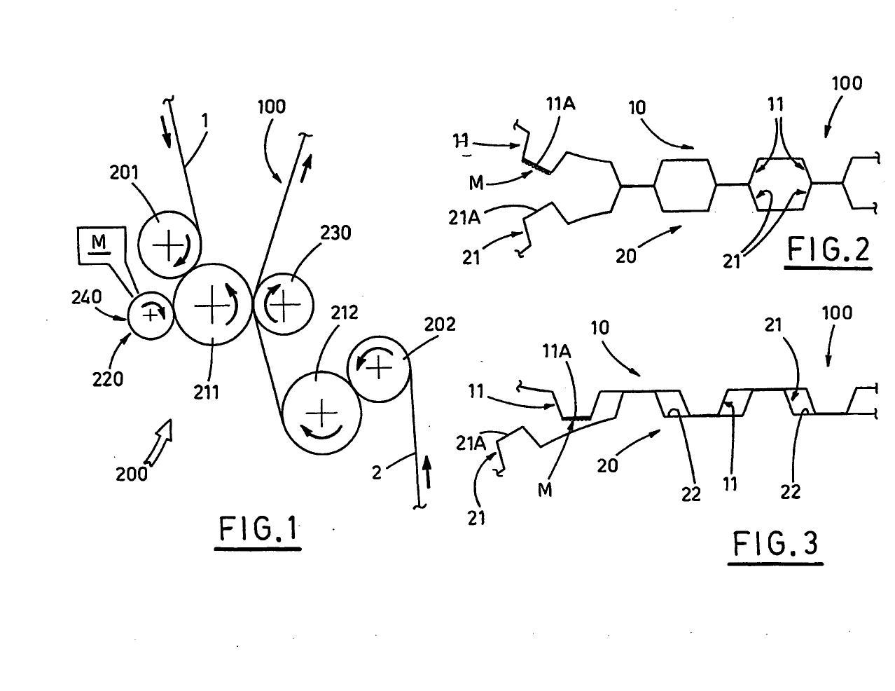

FIG. 2 shows a first possible coupling pattern between the two layers 10, 20, in which the tops 11A of the first layer 10, with spots of said mixture M applied thereto, meet the aligned tops 21A of the embossing relieves 21 of the second layer 20.

FIG. 3 shows a second possible coupling pattern between the two layers 10, 20, in which the tops 11A of the first layer 10, with spots of said mixture M applied thereto, are offset with respect to the tops 21A of the embossing relieves 21 of the second layer 20 and meet the hollows 22 of the latter.

The application of the sanitizing-disinfectant substance S to the tops 11A of the embossing relieves 11 of the web 1, shown in FIGS. 2 and 3, can be obtained also by two variants of said preferred embodiment of the method:
according to the first variant, the application is performed after the embossing step and before said glue C application step, by spot-applying of aqueous solution containing only the sanitizing substance S;
according to the second variant, the application is performed after the embossing step and the glue C application step, likewise by spot-applying of aqueous solution containing only the sanitizing substance S.

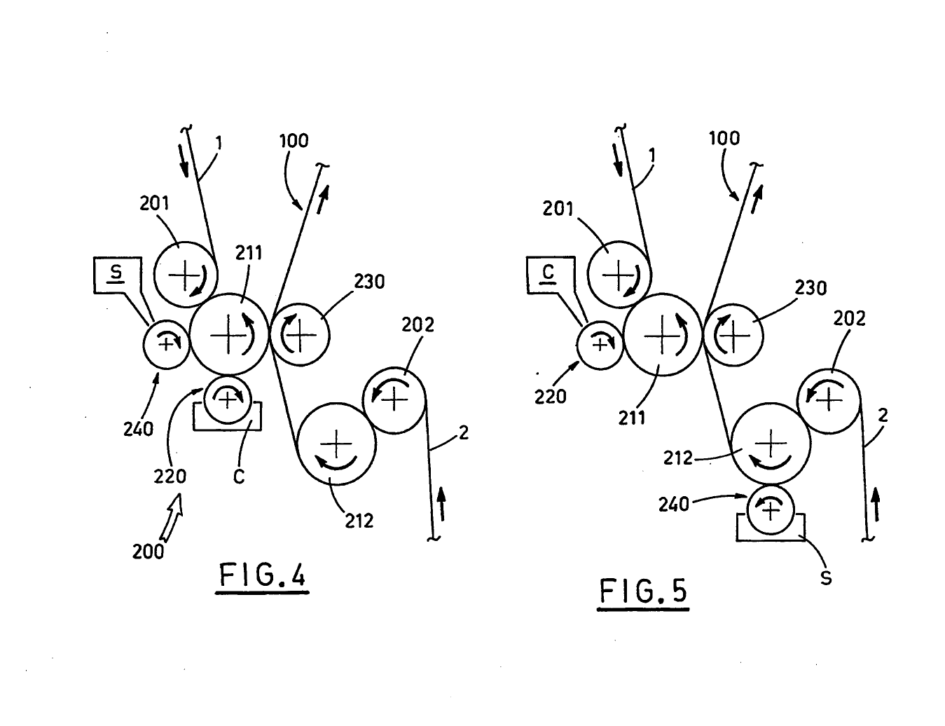

The realization of the above variants requires application means 240 separated from the third roller 220 for the glue C in the apparatus 200; FIG. 4 shows the layout related to the first variant, in which the application means 240, formed e.g. by a relative roller tangential to the embossing roller 211, are situated upstream of the third roller 220, while for the second above mentioned variant it is obviously necessary to invert the positions.

According to a second embodiment of the method, the sanitizing substance S is applied to the continuous web 2 that is opposite to the one aimed at receiving the glue C, after the embossing step, by spot-application of an aqueous solution to the tops 21A of the embossing relieves 21.

Said second embodiment is realized with the application means 240, including e.g. a relative roller, arranged tangential to the corresponding embossing roller 212 (FIG. 5).

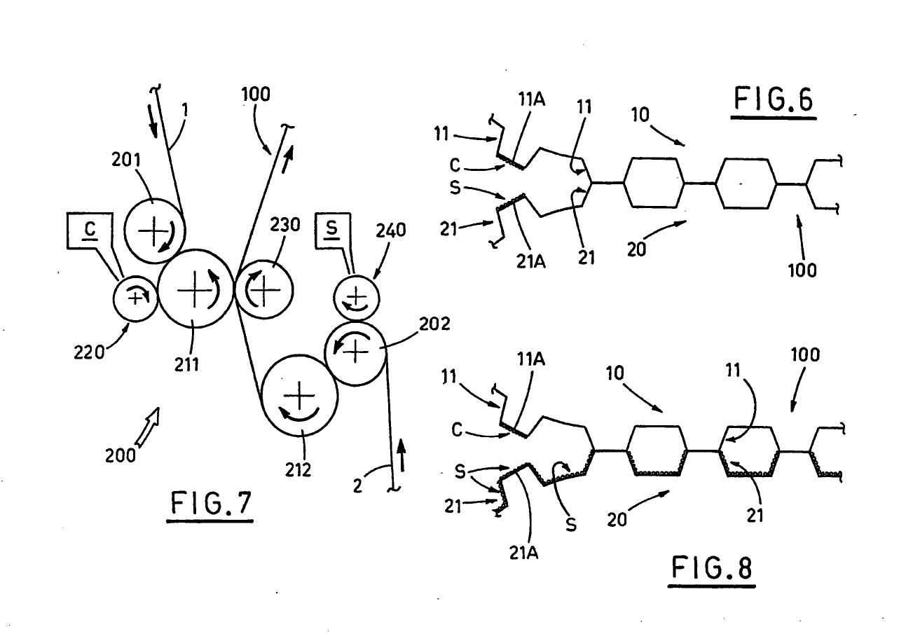

FIG. 6 shows the same coupling pattern between the two layers 10, 20 of FIG. 2, in which the tops 11A of the relieves 11 of the first layer 10, with glue-spots C applied thereto, meet the aligned tops 21A of the embossing relieves 21 of the second layer 20 with the sanitizing substance S spot-applied thereto; the previously described mixture M of glue C and substance S is recomposed due to the joining of the two layers 10, 20.

According to a third embodiment of the method, the sanitizing substance S is applied to one of the continuous webs 1, 2 before the embossing step, in a film of aqueous solution placed onto the smooth surface of said continuous web 1 or 2.

Otherwise, the above film of the sanitizing substance S can be applied by printing techniques or spray techniques.

Said third embodiment is realized with the application means 240, including e.g. a relative roller, or spraying nozzles, arranged upstream of the embossing roller 211 or 212, respectively for the continuous web 1 or 2; according to the solution shown in FIG. 7, relative to the continuous web 2, the application roller 240 is arranged tangential with respect to the feeding roller 202.

According to the configuration regarding the continuous web 1, not shown, the roller 240 is situated tangential to the corresponding feeding roller 201.

FIG. 8 shows the same coupling scheme between the two layers 10, 20 of FIGS. 2 and 6, in relation to the apparatus configuration of FIG. 7; in this case, the tops 11A of the relieves 11 of the first layer 10, with glue-spots C applied thereto, meet the aligned tops 21A of the embossing relieves 21 of the second layer 20 with the film of the sanitizing substance S applied thereto.

It is intuitive to understand that, according to the last embodiment of the method, a bigger quantity of sanitizing substance S is applied, which obviously has stronger sanitizing effects on the layers 10, 20 of embossed paper.

The advantages that the proposed method allows to obtain with respect to the prior art products appear extremely obvious from what has been said above. The proposed method offers high hygienic and aseptic features of the rolls, and of the sheets obtained from the latter, for improved patient's care.

Another important advantage lies in the fact that the apparatus that carries out the method, in all the described embodiments, is substantially identical with the known ones, in the costs terms, as well as in the production speed terms; practically, the only cost increase with respect to the known solutions results from the use of the sanitizing substance.

Consequently, the proposed method in its simplicity allows to offer a product with high quality characteristics, obtained with an insignificant cost increase, which makes it possible to offer it also for articles different than the sheets, such as napkins, handkerchiefs, wash-clothes and others.

However, it is understood that what above is a not limiting example, therefore possible changes of detail, applied to the method steps and/or apparatus, are considered within the protection scope of the claims below.

1. A method for producing paper rolls for examination tables, obtained from a band (100) of embossed paper with two joined layers (10, 20), said band (100) being obtained from two continuous webs (1, 2) subjected to subsequent steps of embossing, glue (C) application, joining and stabilizing, and with said method being characterized in that it includes the application of a sanitizing-disinfectant substance (S) between the two layers (10, 20) of embossed paper before their joining.

2. A method, according to claim 1, characterized in that the sanitizing-disinfectant substance (S) is applied to at least one of said continuous webs (1, 2), on the side matching with the other continuous web.

3. A method, according to claim 2, characterized in that the sanitizing-disinfectant substance (S) is applied to the same continuous web (1) that receives the glue (C) for joining said layers (10, 20).

4. A method, according to claim 3, characterized in that said sanitizing-disinfectant substance (S) is applied after the embossing step and contemporarily with the glue (C) application obtained by spot-application of a mixture (M) in aqueous solution containing suitable percentage of the glue (C) and sanitizing substance (S) to the tops (11A) of the embossing relieves (11).

5. A method, according to claim 3, characterized in that said sanitizing-disinfectant substance (S) is applied after the embossing step and before the glue (C) application, by spot-application of an aqueous solution to the tops (11A) of the embossing relieves (11).

6. A method, according to claim 3, characterized in that said sanitizing-disinfectant substance (S) is applied after said embossing step and glue (C) application, by spot-application of an aqueous solution to the tops (11A) of the embossing relieves (11).

7. A method, according to claim 2, characterized in that the sanitizing-disinfectant substance (S) is applied to the continuous web (2) that is opposite to the one which receives the glue (C) for joining said layers (10, 20).

8. A method, according to claim 7, characterized in that said sanitizing-disinfectant substance (S) is applied after the embossing step by spot-application of an aqueous solution to the tops (21A) of the embossing relieves (21).

9. A method, according to claim 3 or 7, characterized in that said sanitizing-disinfectant substance (S) is applied after the embossing step by application of a film of an aqueous solution to the smooth surface of said continuous web (1) or (2).

10. A method, according to claim 9, characterized in that a film of said sanitizing-disinfectant substance (S) is applied by printing techniques.

11. A method, according to claim 9, characterized in that a film of said sanitizing-disinfectant substance (S) is applied by spray techniques.

12. An apparatus for producing paper rolls for examination tables, obtained with a band (100) of embossed paper of two joined layers (10, 20), with said apparatus (200) having first rollers (201, 202) for feeding two continuous webs (1, 2), to form said layers (10, 20); second rollers (211, 212) for embossing said sheets (1, 2); a third roller (220) for applying glue (C) between said sheets (1, 2); and fourth rollers (230) for coupling and stabilizing the layers (10, 20); with said apparatus (200) characterized in that it includes application means (240), situated upstream of said fourth coupling rollers (230) and applying measured quantities of a sanitizing-substance (S) to at least one of said layers (10, 20), on the side turned toward the other layer.

13. An apparatus, according to claim 12, characterized in that said application means (240) act on the same continuous web (1), on which the third roller (220) acts to apply the glue (C) for joining said layers (10, 20).

14. An apparatus, according to claim 13, characterized in that said application means (240) include said third roller (220) for application of the glue (C), which spot-applies a mixture (M) in aqueous solution, containing suitable percentage of the glue (C) and sanitizing substance (S), to the tops (11A) of the embossing relieves (11) of said continuous web (1).

15. An apparatus, according to claim 13, characterized in that said application means (240) include a roller, which acts tangential to the roller (211) for embossing the continuous web (1) that receives said glue (C), and which is situated upstream of said third roller (220) for applying said glue (C), and which spot-applies an aqueous solution of said sanitizing substance (S) onto the tops (11A) of the embossing relieves (11) of said continuous web (1).

16. An apparatus, according to claim 13, characterized in that said application means (240) include a roller, which acts tangential to the roller (211) embossing the continuous web (1) that receives said glue (C), and which is situated downstream of said third roller (220) for applying said glue (C), and which spot-applies an aqueous solution of said sanitizing substance (S) onto the tops (11A) of the embossing relieves (11) of said continuous web (1).

17. An apparatus, according to claim 12, characterized in that said application means (240) act on the continuous web (2), opposite to the one, on which the third roller (220) acts to apply the glue (C).

18. An apparatus, according to claim 17, characterized in that said application means (240) include a roller, which acts tangential to the roller (212) for embossing the continuous web (2), opposite to the one that receives the glue (C), and which spot-applies an aqueous solution of said sanitizing substance (S) onto the tops (21A) of the embossing relieves (21) of said continuous web (2).

19. An apparatus, according to claim 13 or 17, characterized in that said application means (240) are situated upstream of said embossing rollers (211, 212) and apply a film of aqueous solution of said sanitizing substance (S) to the smooth surface of said continuous web (1 or 2).

20. An apparatus, according to claim 19, characterized in that said application means (240) include a roller, which acts tangential to one of said first feeding rollers (201, 202).

21. An apparatus, according to claim 19, characterized in that said application means (240) include a plurality of spraying nozzles.

22. A method, according to claim 7, characterized in that said sanitizing-disinfectant substance (S) is applied after the embossing step by application of a film of an aqueous solution to the smooth surface of said continuous web (1) or (2).

23. An apparatus, according to claim 17, characterized in that said application means (240) are situated upstream of said embossing rollers (211, 212) and apply a film of aqueous solution of said sanitizing substance (S) to the smooth surface of said continuous web (1 or 2).
